(19) United States
(12) Patent Application Publication
(10) Pub. No.: US 2011/0291533 A1
(43) Pub. Date: Dec. 1, 2011

(54) CABINET FOR AN AIR HANDLING SYSTEM

(75) Inventor: MATTHEW MCFARLAND, COLOGNE, MN (US)

(73) Assignee: MAMMOTH, INC., EDEN PRAIRIE, MN (US)

(21) Appl. No.: 12/786,650

(22) Filed: May 25, 2010

(51) Int. Cl. A47B 81/00; B23P 19/04; F24F 7/00

(52) U.S. Cl. 312/236; 454/284; 29/700

(57) ABSTRACT

A transition barrier for an air handling unit is provided, wherein air handling unit has at least one functional section. The air handling unit also has a cabinet that surrounds the at least one functional section. The transition barrier including a bottom panel having a bottom cutout and a top panel positioned adjacent the bottom panel and having a top cutout aligned with the bottom cutout to form a conduit reception aperture. The conduit reception aperture extending through the transition barrier and configured to receive conduit extending along the air handling unit. The transition barrier extending laterally and vertically between members of the cabinet to isolate the at least one functional section.

### BACKGROUND OF THE INVENTION

The embodiments relate to air handling units and, more particularly, to air handling units having piping and conduit extending therethrough.

Typically, air handling units include a box cabinet structure that has a plurality of cabinet members to support wall panels of the cabinet structure. The cabinet structure encloses components of the air handling unit therein and provides an air-tight and water-tight environment for the components. The air handling unit may be divided into functional sections. The cabinet of the air handling unit divides each of these sections. Each functional section encloses components necessary for the function of that section. For example, the functional sections may include a heating coil section, a fan section, a humidifier section, a cooling coil section, a damper section and/or a filter section.

Utility piping and conduit extend between the functional sections to transfer electrical cables, communications cables, water, gas, coolant, and/or the like between the components of each section. Additionally, the piping and conduit may extend from an interior of the air handling unit to an environment surrounding the unit. It is important that the air seal of the air handling unit cabinet be maintained intact and free from air leakage either between two sections of the air handling unit or between the interior of the air handling unit and its surrounding ambient environment. During assembly, the cabinet is constructed around the components of the air handling unit. Wall panels are positioned within the cabinet to isolate the various functional sections. Generally, apertures are formed in the panels to extend the piping and conduit therethrough. The piping and conduit are then extended through the wall panels of the air handling unit and coupled to the appropriate component. Accordingly, the air handling unit includes a plurality of apertures formed therein to accommodate each component. The apertures may be sealed with an insulation material. However, each aperture still represents a potential leak in the unit. Additionally, the apertures are often formed at a location in the wall panel nearest the component to which the piping and conduit are connected. As such, access to the piping and conduit may be limited after assembly of the air handling unit.

Additionally, due to the configuration of the air handling unit, the piping and conduit may structurally interfere with the air handling unit. Accordingly, the piping and conduit may be difficult to extend directly to a desired component and access to the piping and conduit within the air handling unit may be limited.

A need remains for improved systems and methods to extend piping and conduit through an air handling unit and maintain the integrity of the air seal of the air handling unit cabinet at the apertures formed in the panels to extend the piping and conduit therethrough.

### SUMMARY OF THE INVENTION

In one embodiment, a transition barrier for an air handling unit is provided, wherein air handling unit has at least one functional section. The air handling unit also has a cabinet that surrounds the at least one functional section. The transition barrier includes a bottom panel having a bottom cutout and a top panel positioned adjacent the bottom panel and having a top cutout aligned with the bottom cutout to form a conduit reception aperture. The conduit reception aperture extends through the transition barrier and is configured to receive conduit extending along the air handling unit. The transition barrier extends laterally and vertically between members of the cabinet to isolate the at least one functional section.

In another embodiment, an air handling unit is provided. The air handling unit includes at least one functional section and a cabinet having members that surround the at least one functional section. The air handling unit also includes a transition barrier. The transition barrier includes a bottom panel having a bottom cutout, and a top panel positioned adjacent the bottom panel. The top panel has a top cutout aligned with the bottom cutout to form a conduit reception aperture extending through the transition barrier. The conduit reception aperture is configured to receive conduit extending along the air handling unit. The transition barrier extends laterally and vertically between the cabinet members to isolate the at least one functional section.

In yet another embodiment, a method of assembling an air handling unit is provided. The method includes positioning a bottom panel of a transition barrier within an air handling unit, wherein the bottom panel has a cutout. Conduit is extended through the cutout. A top panel of a transition barrier is positioned adjacent the bottom panel to form the transition barrier. The top panel has a cutout that aligns with the cutout of the bottom panel to form a conduit reception aperture to receive conduit extending along the air handling unit. The transition barrier is configured to isolate at least one functional section of the air handling unit.

### BRIEF DESCRIPTION OF THE DRAWINGS

FIG. 1 is a schematic view of an air handling system formed in accordance with an embodiment.

FIG. 2 is a view of a cabinet that may be used to enclose the air handling system, shown in FIG. 1

FIG. 3 is a top view of a cabinet that may be used to enclose the air handling system, as shown in FIG. 2.

FIG. 4 a perspective view of an air handling system having a conduit passage formed in accordance with an embodiment.

FIG. 5 is a view of a panel system for extending piping or conduit through an air handling system.

FIG. 6 is a view of the panel system shown in FIG. 4 in a coupled position.

FIG. 7 is a flowchart of a method for extending piping or conduit through an air handling system.

FIG. 8 is an alternative panel system for extending piping or conduit through an air handling system.

FIG. 9 is a view of the panel system shown in FIG. 7 in a coupled position.

FIG. 10 is a flowchart of an alternative method for extending piping or conduit through an air handling system.

FIG. 11 is a view of a panel system used to extend piping or conduit to an exterior of an air handling system.

### DETAILED DESCRIPTION OF THE DRAWINGS

The foregoing summary, as well as the following detailed description of certain embodiments will be better understood when read in conjunction with the appended drawings. As used herein, an element or step recited in the singular and proceeded with the word “a” or “an” should be understood as not excluding plural of said elements or steps, unless such exclusion is explicitly stated. Furthermore, references to “one embodiment” are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

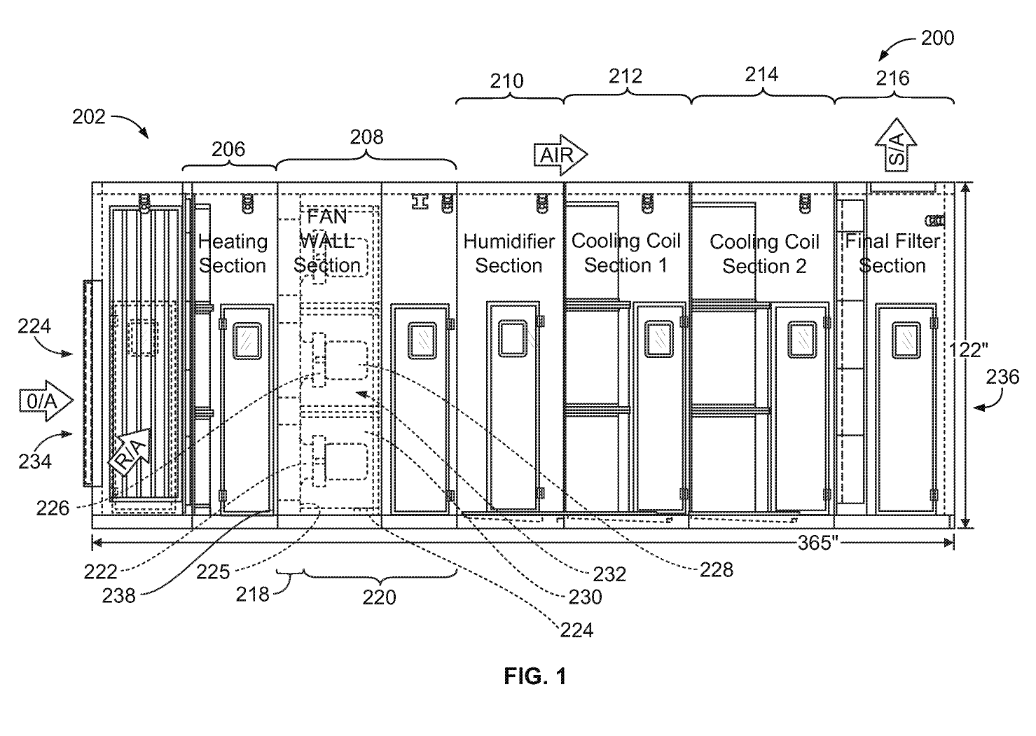

FIG. 1 illustrates an air handling system 200 utilized in accordance with an embodiment. The system 200 includes an inlet 202 that receives air. A heating section 206 that heats the air is included and followed by an air handling section 208. A humidifier section 210 is located downstream of the air handling section 208. The humidifier section 210 adds and/or removes moisture from the air. Cooling coil sections 212 and 214 are located downstream of the humidifier section 210 to cool the air. A filter section 216 is located downstream of the cooling coil section 214 to filter the air. The sections may be reordered or removed. Additional sections may be included.

The air handling section 208 includes an inlet plenum 218 and a discharge plenum 220 that are separated from one another by a bulkhead wall 225 which forms part of a cabinet 224. The air processing system 200 may include a damper positioned at the inlet plenum 218 and/or the discharge plenum 220. Optionally, a damper may be positioned within any of the heating section 206, the air handling section 208, the humidifier section 210, the cooling coil sections 212 and 214, and the filter section 216.

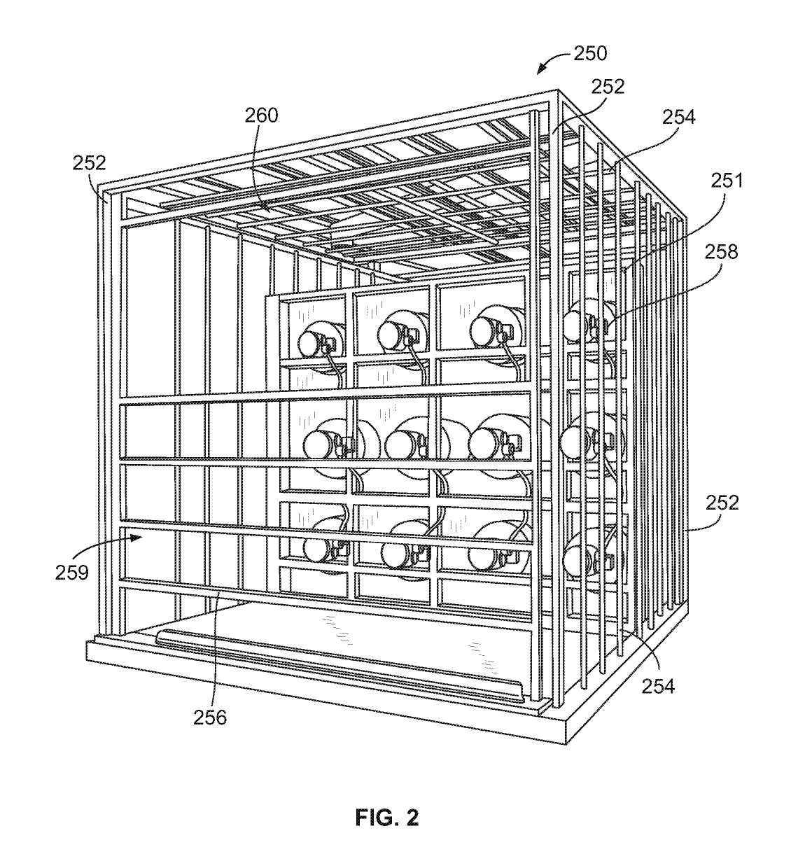

FIG. 2 is a view of a cabinet 250 that may be used to enclose an air handling system 251, such as the air handling system 200 shown in FIG. 1. The cabinet 250 includes corner posts 252 and intermediate posts 254. The corner posts 252 form the corners of the cabinet 250. The intermediate posts 254 are positioned between the corner posts 252. The intermediate posts 254 extend parallel to the corner posts 252. Lateral posts 256 may extend perpendicular to the corner posts 252 and intermediate posts 254. The posts 252, 254, and 256 are configured to retain panels that enclose the air handling system 251. Components 258 of the air handling system 251 are enclosed within the cabinet 250. The components 258 are positioned within functional sections 259 of the air handling system 251. The air handling system 251 may include multiple functional sections 259 separated by the cabinet 250. Optionally, the functional sections 259 may include corridors and/or vestibules positioned within or outside of the air handling system 251. The air handling system 251 also includes a conduit passage 260 extending therethrough. The conduit passage 260 is configured to receive conduit for channeling utilities throughout the air handling system 251. The conduit passage 260 is illustrated as projecting above the functional section 259 of the air handling system 251. Optionally, the conduit passage 260 may project beneath or along the side of the functional section 259. The conduit passage 260 is enclosed by the cabinet 250.

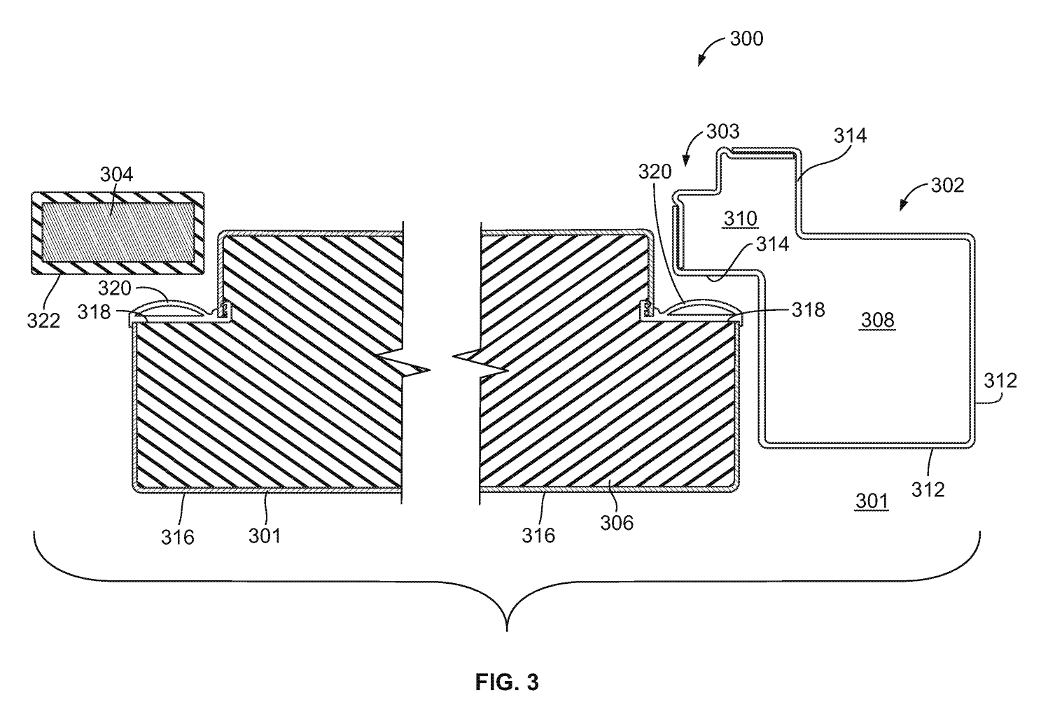

FIG. 3 is a top view of a cabinet 300 that may be used to enclose the air handling system 200, as shown in FIG. 2. The cabinet 300 includes a corner post 302, an intermediate post 304, and a panel 306. The corner post 302 includes an exterior post section 308 and a support section 310. The exterior post section 308 is configured to extend along an exterior 301 of the cabinet 300. The support section 310 is oriented within an interior 303 of cabinet 300. The exterior post section 308 includes a pair of front faces 312. The support section 310 includes a pair of coupling surfaces 314. The front faces 312 form an exterior corner of the air handling system 200. The coupling surfaces 314 support the panel 306. The panel 306 includes a front face 316 and a pair of coupling surfaces 318. One of the coupling surfaces 318 is coupled to a coupling surface 314 of the corner post 302. In the example embodiment, the coupling surface 318 includes a rounded seal 320. The seal 320 flattens against the coupling surface 314 to form an air tight interface. Optionally, the seal 320 may be flat and/or include threads, protrusions, and/or fins. Additionally, the cabinet 300 may not include the seal 320. The intermediate post 304 includes a coupling surface 322. One of the coupling surfaces 318 of the panel 306 is configured to couple to the coupling surface 322 of the intermediate post 304. The coupling surface 318 may include a seal 320 to form an air tight interface with the intermediate post 304.

The corner posts 302 are positioned at the corners of an air handling system, such as the system 200 illustrated in FIG. 1. At least one intermediate post 304 is positioned between each corner post 302 along each side of the air handling system. The coupling surface 322 of each center post 304 is aligned with a coupling surface 314 of a corner post 302. The panels 306 are coupled to and extend between the corner posts 302 and the center posts 304. The panels 306 are coupled so that the coupling surfaces 318 form an air tight interface with one of the coupling surface 314 of the corner post 302 or the coupling surface 322 of the intermediate post 304. The front faces 316 of the panels 306 and the front faces 312 of the corner posts 302 form a substantially planar face along the exterior 301 of the cabinet 300.

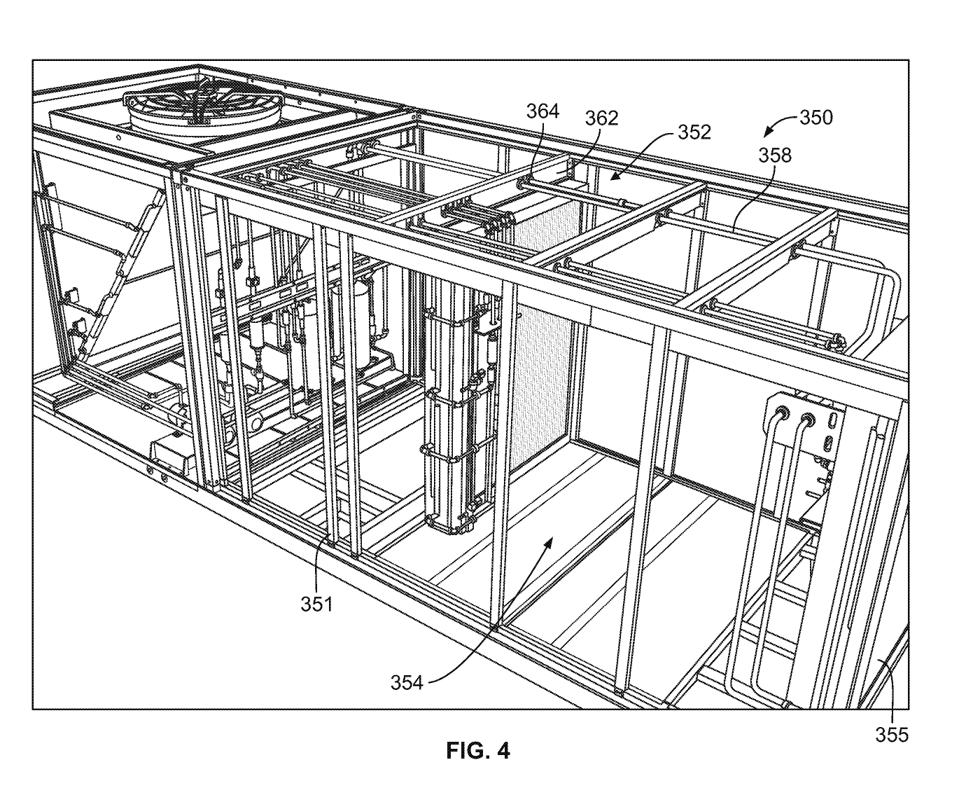

FIG. 4 a perspective view of a portion of an air handling system 350 having a support structure 351. The support structure 351 may be formed from the cabinet 300 illustrated in FIG. 3. The support structure 351 encloses at least one functional section 354 of the air handling system 350. A conduit passage 352 extends along a top of the functional section 354. In an embodiment having multiple functional sections 354, the functional sections may be separated and isolated by a functional section partition. The functional section partition may also isolate the functional sections 354 from the environment surrounding the air handling system 350. The functional section 354 may include a heating section, an air handling section, a humidifier section, a cooling coil section, and/or a filter section.

In one embodiment, the conduit passage 352 may be formed as a part of the functional sections 354. In such an embodiment, the conduit passage 352 extends above the functional components within the functional section 354. Alternatively, the conduit passage 352 may be isolated from the functional sections 354 by a conduit passage partition. In such an embodiment, the conduit passage 352 occupies a space separate from the functional sections 354. The conduit passage 352 extends along the support structure 351 and is positioned above the functional section 354. In an alternative embodiment, the conduit passage 352 may extend below the functional section 354. Additionally, the conduit passage 352 may extend along any of the sides of the functional sections 354. The conduit passage 352 projects along a length of the air handling system 350. Optionally, the conduit passage 352 may only project along a portion of the air handling system length.

The conduit passage 352 may be laterally separated from the functional section 354 by a conduit passage partition. The conduit passage partition creates an airtight interface between the conduit passage 352 and the functional sections 354. Conduit 358 extends along the conduit passage 352. The conduit 358 may carry electricity, water, coolant, gases, and the like throughout the air handling system 350. In one embodiment, conduit 358 is refrigerant piping. Optionally, conduit 358 may include any type of piping and/or electrical raceways. The conduit 358 may carry utilities between compartments in the functional section 354. The conduit 358 may also carry utilities to and from an environment surrounding the air handling system 350 through the support structure 351. In an embodiment having a conduit passage partition, the conduit 358 extends between the conduit passage 352 and functional section 354 through an aperture formed in the conduit passage partition. The aperture may be sealed to maintain an air tight interface between the conduit 358 and the aperture. Optionally, the aperture is not sealed and the air tight interface is maintained at the support structure 351.

A transition barrier 362 isolates portions of the conduit passage 352. The transition barrier 362 extends laterally and vertically along the conduit passage 352. The transition barrier 362 extends along a plane of the functional section partition 355. The transition barrier 362 isolates adjacent functional sections 354. The transition barrier 362 may also isolate the functional sections 354 from an environment surrounding the air handling unit 350. In one embodiment, the transition barrier 362 may be formed separately from a functional section partition and coupled to a conduit passage partition to form an airtight interface. Optionally, the transition barrier 362 may be formed as a portion of a functional section partition that extends into the conduit passage 352.

Apertures 364 are formed in the transition barrier 362. The apertures 364 enable the conduit 358 to extend between functional sections 354 of the air handling system 350. The apertures 364 may also extend through an outer wall of the support structure 351. In such an embodiment, the apertures 364 enable conduit 358 to pass into and out of the air handling system 351. The apertures 364 are sized and shaped to receive the conduit 358. The apertures 364 are sealed to form an airtight interface between the transition barrier 362 and the conduit 358.

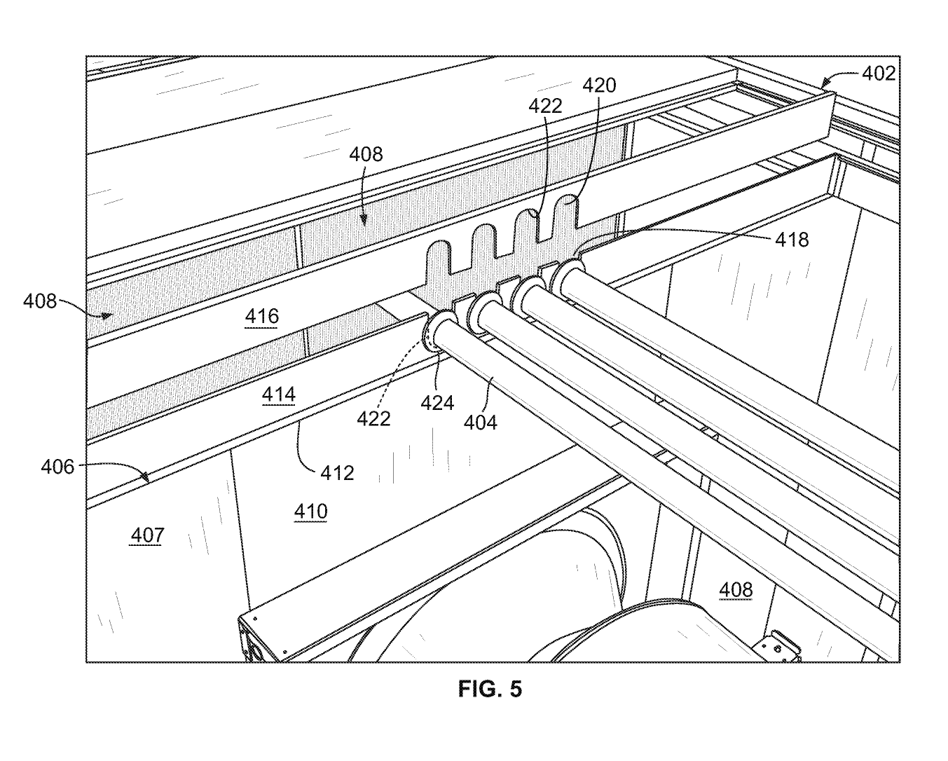

FIG. 5 is a view of a transition barrier 402 for extending conduit 404 through a conduit passage 406 of an air handling system 400. The air handling system 400 has a support structure 410. The support structure 410 may be formed from the cabinet 300 illustrated in FIG. 3. The air handling system 400 also includes at least one functional section 408 surrounded by the support structure 410. The support structure 410 includes at least one functional section partition 407 to separate and isolate the functional sections 408. The functional section partition 407 may extend laterally and vertically between adjacent functional sections 408. Optionally, the functional section partition 407 may form an exterior wall of the support structure 410. The conduit passage 406 extends above the functional section 408. Optionally, the conduit passage 406 may extend below and/or along a side of the functional section 408. In the example embodiment, the conduit passage 406 is formed within the space defined by the functional section 408. The conduit passage 406 extends above the components 409 of the functional section 408. Optionally, the conduit passage 406 may be separated and isolated from the functional section 408 by a conduit passage partition, as illustrated in FIG. 4.

The support structure 410 includes a top 412. The top 412 extends across the functional section partition 407. The transition barrier 402 is coupled to the top 412 of the support structure 410. An airtight interface is formed between the support structure 410 and the transition barrier 402. In an alternative embodiment, the transition barrier 402 is formed as a part of the support structure 410. Optionally, the transition barrier 402 is coupled to a bottom (not shown) of the support structure.

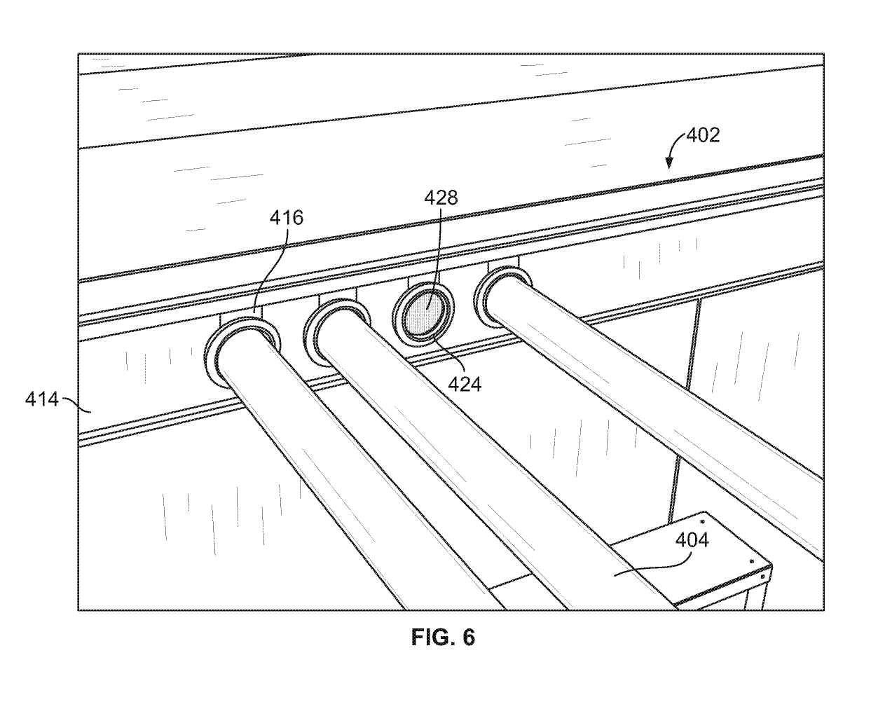

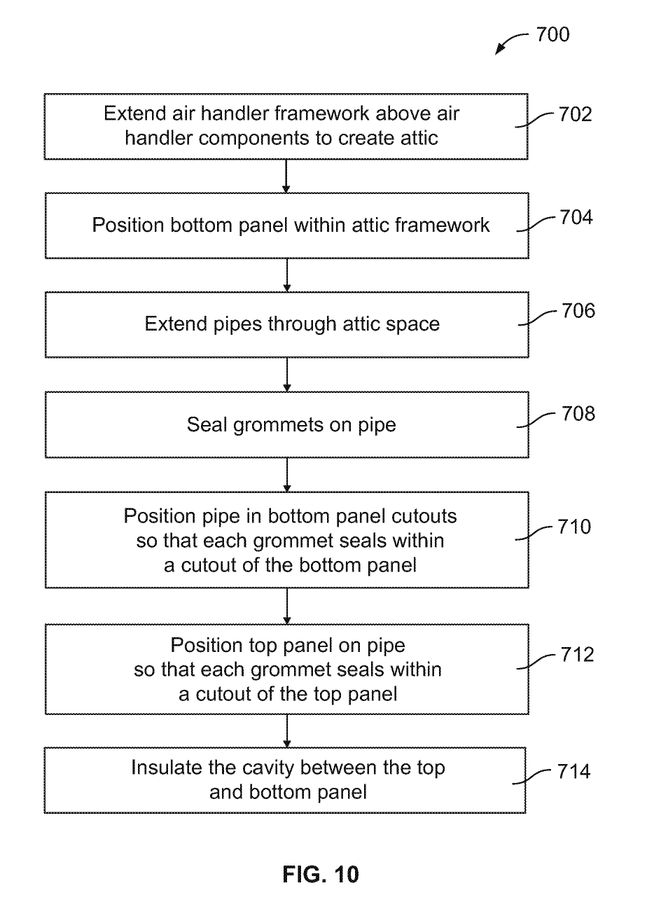

The transition barrier 402 includes a bottom panel 414 and a top panel 416. The bottom panel 414 is coupled to the top 412 of the support structure 410. The bottom panel 414 extends along the functional section partition 407 and forms an airtight interface therewith. Optionally, the bottom panel 414 may be formed as a portion of the top 412 of the functional section partition 407. The bottom panel 414 includes a bottom cutout 418. The top panel 416 includes a top cutout 420. The cutouts 418 and 420 have a rounded end 422 sized to the conduit 404. The top cutout 420 is configured to align with the bottom cutout 418. Aligning the cutouts 418 and 420 forms an aperture (shown in FIG. 6) that is sized to receive the conduit 404. A grommet 424 surrounds the conduit 404. Optionally, the grommet 424 may be an insulative wrap that is wrapped around the conduit 404. The grommet 424 forms a seal between the conduit 404 and the rounded ends 422 of the cutouts 418, 420 to form an air tight interface. FIG. 5 illustrates the conduit 404 extending between adjacent functional sections 408. The transition barrier 402 described herein may also be used to extend the conduit 404 to an exterior of the air handling system 400, as illustrated in FIG. 10.

FIG. 6 is a view of the transition barrier 402 in a coupled configuration. The top panel 416 and the bottom panel 414 are positioned in a flush configuration to form the transition barrier 402. The cutouts 418, 420 are aligned to form the apertures 428. The apertures 428 extend through the transition barrier 402. The apertures 428 are sized to receive the conduit 404. The exemplary embodiment illustrates four apertures 428. Alternatively, any number of apertures 428 may be formed in the transition barrier 402. The number of apertures 428 is dependant on the number of conduit 404 extending through the air handling system 400. The apertures 428 are also illustrated as having a common spacing therebetween. Optionally, the spacing of the apertures 428 is dependant on the spacing of the conduit 404. Moreover, the apertures 428 are aligned in a common plane that is parallel to a plane of the support structure 410. Optionally, the apertures 428 are not aligned in a plane, but rather, aligned with respect to an alignment of the conduit 404.

A grommet 424 is positioned within each aperture 428. The grommet 424 forms an air tight interface between the conduit 404 and the corresponding aperture 428. The grommet 424 is formed from an insulation material, such as rubber or the like. Optionally, the aperture may be filled with an insulation material, such a gel or the like. In the exemplary embodiment, the conduit 404 is round. The cutouts 418, 420 and the grommet 424 are configured to receive a round conduit 404. Optionally, the conduit 404 may be squared, hexagonal, octagonal, and/or have any suitable shape. The cutouts 418, 420 are shaped and sized to form an aperture 428 having a common size and shape with the conduit 404. The grommets 424 also have a size and shape that is common with the size and shape of the conduit 404.

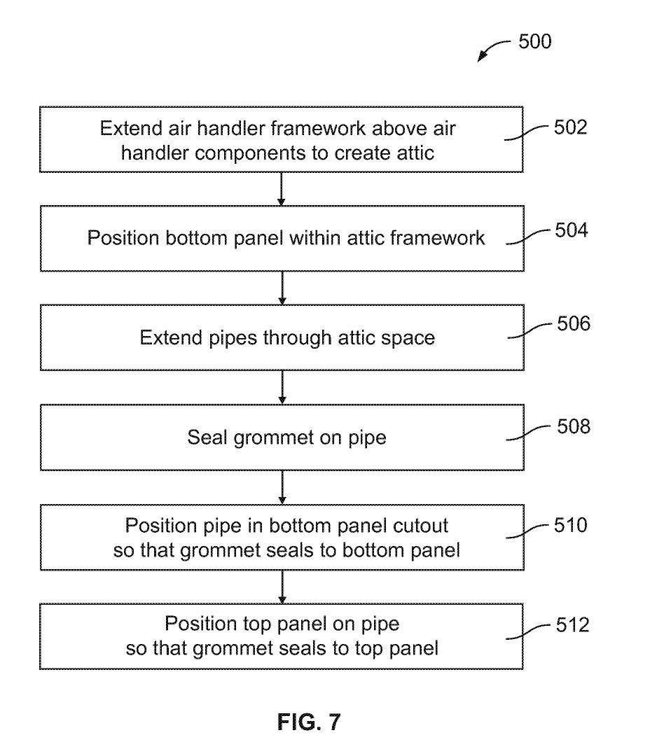

FIG. 7 is a flowchart of a method 500 for extending conduit through an air handling system in accordance with an embodiment. The air handling system includes at least one functional section. The air handling system may also include multiple functional sections separated and isolated by a functional section partition. A functional section partition may be formed as part of a wall panel of the air handling system.

At 502, a conduit passage is created in the air handling system. The conduit passage extends above at least one functional section of the air handling system. Optionally, the conduit passage may extend below and/or along a side of the functional sections of the air handling system. The conduit passage may be separated from the functional sections by a conduit passage partition. Optionally, the conduit passage may be formed in a space defined by the functional sections. The conduit passage extends in a space unoccupied by components of the air handling system. The conduit passage is configured to receive conduit therethrough.

At 504, a bottom panel of a transition barrier is extended vertically and laterally within the conduit passage. The bottom panel may be coupled to a top of the functional section partition. Optionally, the bottom panel may be formed as a portion of the functional section partition. The bottom panel isolates at least one functional section of the air handing system. The bottom panel may isolate adjacent functional sections. Alternatively, the bottom panel may isolate a single functional section from the environment surrounding the air handlings unit. The bottom panel includes at least one cutout configured to receive a conduit.

At 506, at least one conduit is extended through the conduit passage of the air handling system. The conduit is configured to carry at least one of electricity, gas, water, coolant, and the like to the functional sections of the air handling system. The conduit may extend from the environment surrounding the air handling system into and/or out of the air handling system. Optionally, the conduit may extend between functional sections of the air handling system. The conduit is configured to extend through the transition barrier.

At 508, a grommet is positioned on the conduit. The grommet is sized and shaped to form an air tight interface between the grommet and the conduit. The grommet is positioned at a location on the conduit relative to the portion of the conduit configured to extend through the bottom panel. Optionally, the transition barrier may be sealed with an insulation material after the assembly of the transition barrier.

At 510, the conduit is positioned within the cutout of the bottom panel. The conduit is positioned so that a portion of the grommet seals to a portion of the cutout to form an air tight interface between the grommet and the bottom panel. The grommet includes a pair of seals extending the circumference of the grommet. A channel is formed between the seals. The conduit is positioned in the bottom panel so that the cutout of the bottom panel is received in the channel of the grommet. Each of the pair of seals extends along one of opposite faces of the bottom panel.

At 512, a top panel is positioned flush with the bottom panel. The top panel includes a cutout that aligns with the cutout of the bottom panel. A portion of the top panel cutout engages a portion of the grommet to form an air tight interface. The top panel is positioned so that the cutout of the top panel is received in the channel of the grommet. Each of the pair of seals extends along one of opposite faces of the top panel. The top panel cutout and the bottom panel cutout form an aperture that surrounds the conduit. The aperture is sized and shaped relative to the size and shape of the conduit. The grommet extends along a circumference of both the conduit and the aperture. The grommet forms an air tight interface between the conduit and the aperture.

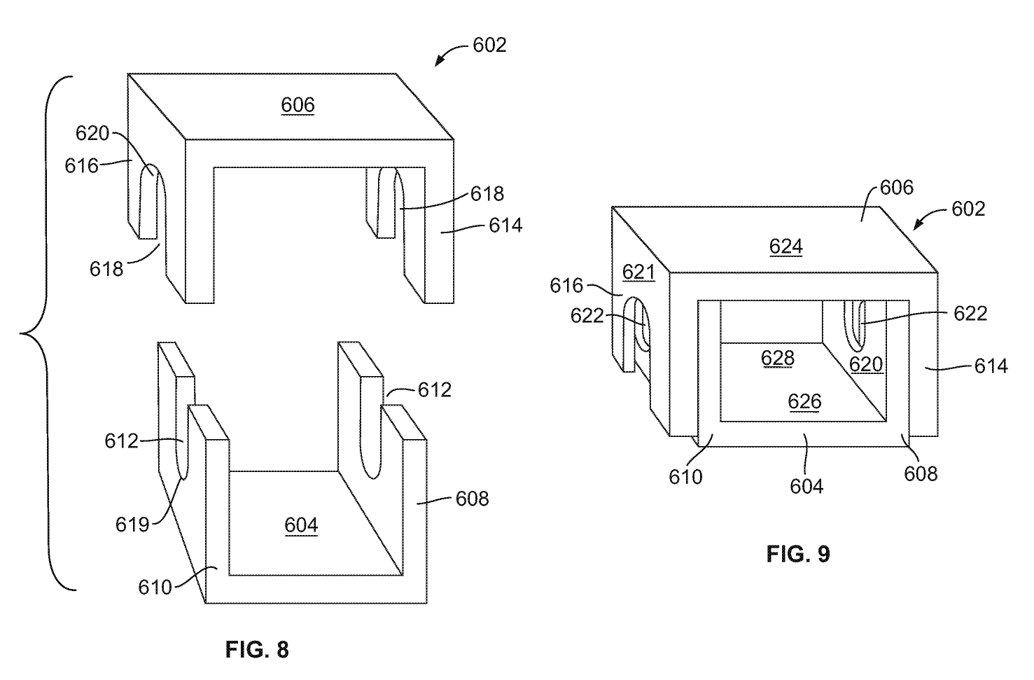

FIG. 8 is an alternative transition barrier 602 for extending conduit (not shown) through a conduit passage of an air handling system (not shown). The transition barrier 602 includes a bottom panel 604 and a top panel 606. The bottom panel 604 includes a first panel 608 and a second panel 610. Each panel 608 and 610 includes a bottom cutout 612. The top panel 606 also includes a first panel 614 and a second panel 616. Each panel 614 and 616 includes a top cutout 618. The cutouts 612 and 618 have rounded ends 619 sized and shaped to the conduit. The cutouts 612 and 618 may also include any sized and shaped ends 619 that are common to the size and shape of the conduit.

The bottom panel 604 and the top panel 606 are configured to align. The first panels 608 and 614 align substantially flush. The second panels 610 and 616 align substantially flush. Each cutout 612 aligns with a corresponding cutout 618. Aligning the cutouts 612 and 618 forms apertures (shown in FIG. 9) that are sized to receive the conduit. The apertures formed in the first panels 608, 614 are aligned with the apertures formed in the second panels 610, 616. A grommet is configured to be positioned within each aperture. The grommet forms an air tight interface between the conduit and the apertures.

FIG. 9 is a view of the transition barrier 602 shown in FIG. 8 in a coupled position. The top panels 606 and the bottom panels 604 are positioned in a flush configuration to form walls 620, 621. The first panels 608 and 614 are positioned flush to form wall 620. The second panels 610 and 616 are positioned flush to form wall 621. The cutouts 612 and 618 are aligned to form apertures 622. The apertures 622 extend through the walls 620, 621. The apertures 622 are sized to receive conduit. A grommet (not shown) is positionable within each aperture 622. The grommet forms an air tight interface between the conduit and the corresponding apertures 622. In the exemplary embodiment, the cutouts 612, 618 are configured to receive a round conduit. Optionally, the conduit may be squared, hexagonal, octagonal, and/or have any suitable shape. The cutouts 612, 618 are shaped and sized to form apertures 622 having a common size and shape with the conduit. The grommets also have a size and shape that is common with the size and shape of the conduit.

The top panel 606 includes a top portion 624 extending between the first panel 608 and the second panel 610. The bottom panel 604 includes a bottom portion 626 extending between the first panel 614 and the second panel 616. The walls 620, 621, the top portion 624, and the bottom portion 626 form a cavity 628. The conduit extends through the cavity 628 between apertures 622. The cavity 628 may be filled with an insulation material, for example, fiberglass, foam and/or gel. Additionally, the cavity 628 may be filled with a sound attenuation material.

Optionally, the top panel 606 does not include the top portion 624 and the first panel 608 and the second panel 610 are formed from separate pieces. Additionally, the bottom panel 604 may not include the bottom portion 626 and the first panel 614 and the second panel 616 are formed from separate pieces. In such an embodiment, the walls 620 and 621 may form a cavity with portions of the air handler frame. This cavity may be filled with insulation.

The transition barrier 602 shown in FIGS. 8 and 9 extends through a conduit passage of an air handling system. The transition barrier 602 may extend along a functional section partition that isolates a functional section of the air handling system from an adjacent functional section or from the environment surrounding the air handling system. The bottom panel 604 may be coupled to a functional section partition. Optionally, the bottom panel 604 may be formed as a portion of the functional section partition.

FIG. 10 is a flowchart of an alternative method 700 for extending conduit through an air handling system. The air handling system includes at least one functional section. The air handling system may also include multiple functional sections separated and isolated by a functional section partition. A functional section partition may be formed as part of a wall panel of the air handling system.

At 702, a conduit passage is created in the air handling system. The conduit passage may extend above, below, and/or along the side of at least one functional section of the air handling system. The conduit passage may also be isolate from the functional sections by a conduit passage partition. The conduit passage is configured to receive conduit therethrough.

At 704, a bottom panel is positioned within the conduit passage. The bottom panel may be coupled to the functional section partition. Optionally, the bottom panel may be formed by a portion of the functional section partition. The bottom panel includes a first panel and a second panel. Each of the first panel and the second panel includes at least one cutout configured to receive a conduit. The cutout of the first panel and the second panel are aligned.

At 706, at least one conduit is extended through the conduit passage of the air handling system. The conduit is configured to carry at least one of electricity, gas, water, coolant, and the like to the functional sections of the air handling system. The conduit may extend from an environment surrounding the air handling system into or out of the air handling system. Optionally, the conduit may extend between adjacent functional sections of the air handling system.

At 708, a pair of grommets is positioned on the conduit. The grommets are sized and shaped to form an air tight interface between the grommet and the conduit. The grommets are positioned at a location on the conduit relative to the portions of the conduit configured to extend through the cutouts of the first and second panels. Optionally, the transition barrier may be sealed with an insulation material after the assembly of the transition barrier.

At 710, the conduit is positioned within each of the cutouts of the bottom panel. The conduit is positioned so that a portion of a first grommet seals to a portion of the cutout formed in the first panel. The first grommet seals to the first panel to form an air tight interface between the first grommet and the first panel. A second grommet seals to a portion of the cutout formed in the second panel. The second grommet seals to the second panel to form an air tight interface between the second grommet and the second panel. The grommets include a pair of seals extending the circumference of the grommet. A channel is formed between the seals. The conduit is positioned in the bottom panel so that the cutouts of the bottom panel are received in the channels of the grommet. Each of the pair of seals extends along one of opposite faces of the bottom panel.

At 712, a top panel is positioned flush with the bottom panel. The top panel includes a first panel and a second panel. The first panels of the top and bottom panels align. The second panels of the top and bottom panels align. The first and second panels of the top panel include cutouts that align with the cutouts of the first and second panel of the bottom panel. A portion of the first panel cutout engages a portion of the first grommet to form an air tight interface. A portion of the second panel cutout engages a portion of the second grommet to form an air tight interface. The top panel is positioned on the conduit so that the cutouts of the top panel are received in the channels of the grommet. Each of the pair of seals extends along one of opposite faces of the top panel.

The top panel cutouts and the bottom panel cutouts form apertures that surround the conduit. The apertures are sized and shaped relative to the size and shape of the conduit. The first and second grommets extend along a circumference of both the conduit and the aperture. The grommets form an air tight interface between the conduit and the aperture.

The top panel and the bottom panel form a cavity. At 714, the cavity is filled with an insulation material. The insulation material may be fiberglass, foam, gel, and/or any other suitable insulation material. Optionally, the cavity may be filled with a sound attenuation material.

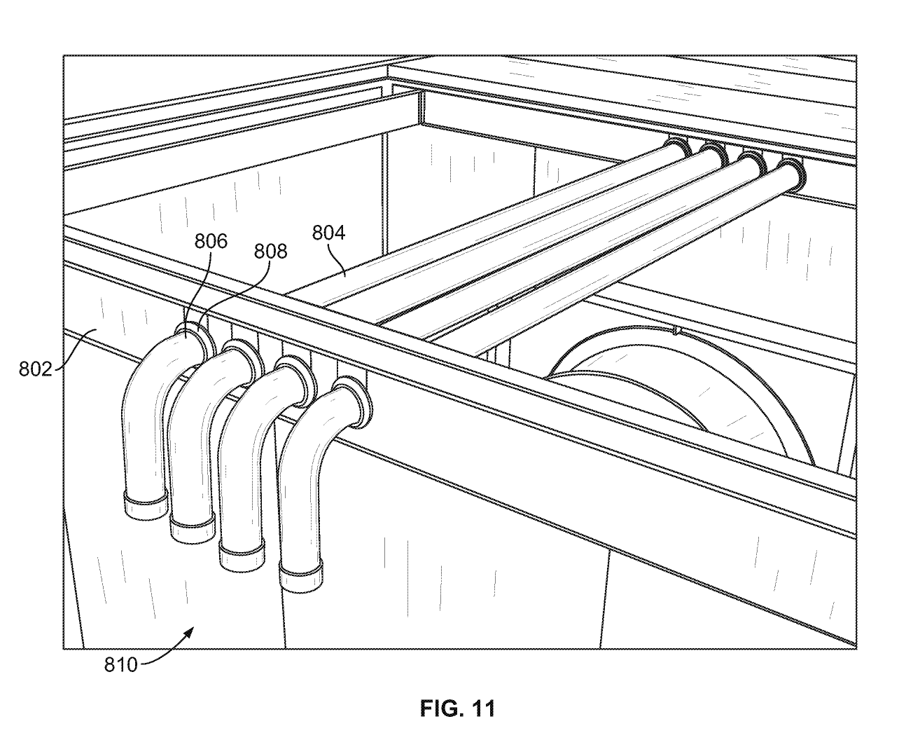

FIG. 11 is a view of a transition barrier 802 utilized to extend conduit 804 to an air handling system 800 from an environment 810 surrounding the air handling system 800. The conduit 804 extends through apertures 806. Grommets 808 are positioned within the apertures 806 to form an air tight interface between the conduit 804 and the transition barrier 802. The transition barrier 802 may be common to the transition barrier 402, shown in FIGS. 5 and 6. Optionally, the panel system may be common to the transition barrier 602, shown in FIGS. 8 and 9.

The various embodiments described herein enable conduit to be installed in an air handling system without interfering with the components of the system. The embodiments described create a conduit passage for installing the conduit that is remote from the compartments of the air handling system. The embodiments enable electricity, gas, water, and/or coolant to be carried into, out of, and throughout the air handling system. The embodiments also improve installation and maintenance time. Additionally, the embodiments provide an air tight interface between the conduit and the cabinet of the air handling system.

The embodiments described herein are described with respect to an air handling system. Optionally, the described embodiments may be used in a clean room environment. Additionally, the embodiments may be used in residential HVAC systems. The embodiments may be used with precision air control systems, DX and chilled-water air handlers, data center cooling systems, process cooling systems, humidification systems, and factory engineered unit controls. The embodiments may also be used with commercial and/or residential ventilation products.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the various embodiments of the invention without departing from their scope. While the dimensions and types of materials described herein are intended to define the parameters of the various embodiments of the invention, the embodiments are by no means limiting and are exemplary embodiments. Many other embodiments will be apparent to those of skill in the art upon reviewing the above description. The scope of the various embodiments of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

This written description uses examples to disclose the various embodiments of the invention, including the best mode, and also to enable any person skilled in the art to practice the various embodiments of the invention, including making and using any devices or systems and performing any incorporated methods. The patentable scope of the various embodiments of the invention is defined by the claims, and may include other examples that occur to those skilled in the art. Such other examples are intended to be within the scope of the claims if the examples have structural elements that do not differ from the literal language of the claims, or if the examples include equivalent structural elements with insubstantial differences from the literal languages of the claims.

What is claimed is:

1. A transition barrier for an air handling unit, the air handling unit having at least one functional section, the air handling unit further having a cabinet that surrounds the at least one functional section; the transition barrier comprising:
a bottom panel having a bottom cutout; and
a top panel positioned adjacent the bottom panel and having a top cutout aligned with the bottom cutout to form a conduit reception aperture, the conduit reception aperture extending through the transition barrier and configured to receive conduit extending along the air handling unit,
the transition barrier extending laterally and vertically between members of the cabinet to isolate the at least one functional section.

2. The transition barrier of claim 1, wherein the air handling unit includes a first functional section and a second functional section, the transition barrier extending laterally and vertically between the first and second functional section to isolate the first functional section from the second functional section.

3. The transition barrier of claim 1, wherein the air handling unit includes a conduit passage extending adjacent the at least one functional section, the transition barrier extending laterally and vertically through the conduit passage to isolate the at least one functional section.

4. The transition barrier of claim 1, wherein the at least one functional section is isolated by a functional section partition, the transition barrier extending from the functional section partition.

5. The transition barrier of claim 1, wherein the cabinet of the air handling unit includes a plurality of walls, the transition barrier forming at least a portion of a wall of the air handling unit.

6. The transition barrier of claim 1 further comprising a grommet positioned within the conduit reception aperture, the grommet configured to seal conduit within the conduit reception aperture.

7. The transition barrier of claim 1, wherein:
the bottom panel comprises a first portion and a second portion parallel to the first portion, the first portion and the second portion having aligned cutouts; and
the top panel comprises a first portion and a second portion parallel to the first portion, the first portion and the second portion having aligned cutouts, wherein the first portion of the bottom panel is positioned adjacent the first portion of the top panel so that the first portion cutouts align to form a first conduit reception aperture, and the second portion of the bottom panel is positioned adjacent the second portion of the top panel so that the second portion cutouts align to form a second conduit reception aperture aligned with the first conduit reception aperture.

8. The transition barrier of claim 7, wherein the first portion and second portion of the bottom and top panels form a cavity, the cavity filled with insulation.

9. An air handling unit comprising:
least one functional section;
a cabinet having cabinet members that surround the at least one functional section; and
a transition barrier comprising:
a bottom panel having a bottom cutout; and
a top panel positioned adjacent the bottom panel and having a top cutout aligned with the bottom cutout to form a conduit reception aperture extending through the transition barrier and configured to receive conduit extending along the air handling unit,
the transition barrier extending laterally and vertically between the cabinet members to isolate the at least one functional section.

10. The air handling unit of claim 9 further comprising:
a first functional section; and
a second functional section adjacent the first functional section,
the transition barrier extending laterally and vertically between the first and second functional section to isolate the first functional section from the second functional section.

11. The air handling unit of claim 9 further comprising a conduit passage extending adjacent the at least one functional section, the transition barrier extending laterally and vertically through the conduit passage to isolate the at least one functional section.

12. The air handling unit of claim 9 further comprising a functional section partition to isolate the at least one functional section, the transition barrier extending from the functional section partition.

13. The air handling unit of claim 9, wherein the cabinet comprises a plurality of walls, the transition barrier forming at least a portion of a wall.

14. The air handling unit of claim 9 further comprising a cavity formed within the transition barrier, the cavity filled with insulation.

15. A method of assembling an air handling unit, the method comprising:
positioning a bottom panel of a transition barrier within an air handling unit, the bottom panel having a cutout;
extending conduit through the cutout;
positioning a top panel of a transition barrier adjacent the bottom panel to form the transition barrier, the top panel having a cutout that aligns with the cutout of the bottom panel to form a conduit reception aperture to receive conduit extending along the air handling unit, the transition barrier configured to isolate at least one functional section of the air handling unit.

16. The method of claim 15, wherein extending conduit further comprises extending conduit through a conduit passage that is isolated from at least one functional section of the air handling unit.

17. The method of claim 15, wherein:
positioning a bottom panel further comprises positioning a bottom panel having a first portion and an second portion parallel to the first portion, the first portion and the second portion having aligned cutouts,
positioning a top panel further comprises positioning a top panel having a first portion and an second portion parallel to the first portion, the first portion and the second portion having aligned cutouts,
the method further comprising positioning the first portion of the bottom panel adjacent the first portion of the top panel so that the first portion cutouts align to form a first conduit reception aperture, and
positioning the second portion of the bottom panel adjacent the second portion of the top panel so that the second portion cutouts align to form an second conduit reception aperture aligned with the first conduit reception aperture; and
extending the conduit through each of the first conduit reception aperture and the second conduit reception aperture.

18. The method of claim 17 further comprising:
positioning the top panel adjacent the bottom panel to form a cavity between the first and second portions of the bottom and top panel; and
filling the cavity with insulation.

19. The method of claim 15 further comprising forming the transition barrier between a first functional section and a second functional section of the air handling unit.

20. The method of claim 15 further comprising forming the transition barrier in a wall of the air handling unit.
